(19) United States
(12) Patent Application Publication
(10) Pub. No.: US 2003/0093788 A1
(43) Pub. Date: May 15, 2003

(54) Automatic emergency message display television receiver

(76) Inventor: Shigenori Takenaka, Takatsuki (JP)

Correspondence Address: WENDEROTH, LIND & PONACK, L.L.P., 2033 K STREET N. W., SUITE 800, WASHINGTON, DC, 20006-1021, US

(21) Appl. No.: 10/291,662

(22) Filed: Nov. 12, 2002

(30) Foreign Application Priority Data
Nov. 12, 2001 (JP) 2001-345602

(51) Int. Cl. H04N 7/025; H04N 7/10; H04N 9/64; H04N 5/445

(52) U.S. Cl. 725/33; 725/32; 348/563

(57) ABSTRACT

An automatic emergency message display television receiver is provided that is capable of receiving an emergency message for presentation to a viewer, irrespectively of the type of a selected audiovisual signal source. An automatic emergency message display television receiver (EBa) automatically displays an emergency message (Sm) carried on a received broadcast wave on a screen that is displaying video reproduced from audiovisual signals supplied by different audiovisual signal sources. In the television receiver (EBa), an emergency message reproducing section (EMa) receives a broadcast wave (SW) to reproduce an emergency message (Sm, Svem).

### BACKGROUND OF THE INVENTION

1. Field of the Invention

The present invention relates to television receivers capable of automatically presenting an audio or visual emergency message to be broadcasted, for example, when a natural disaster occurs or upon arrival of breaking news, even while another audio or video program is being reproduced from audiovisual signals supplied by an external audiovisual signal source typified by a videocassette recorder (VCR) or a television game machine.

2. Description of the Background Art

Conventional television receivers can be broadly divided into two categories depending upon how audio and video programs reproduced from audiovisual signals supplied by a plurality of available audiovisual signal sources are presented. Television receivers of a first type display video output supplied by only a single audiovisual signal source on a monitor, which is a video presenting means, and produce audio output supplied by the same audiovisual signal source from a loudspeaker, which is an audio presenting means. Television receivers of a second type display video output from different audiovisual signal sources on different sub-screens provided on a screen of a monitor, and produce audio output from only one of those audiovisual signal sources from a loudspeaker. For convenience in description, the television receivers of the first type are hereinafter referred to as single-screen television receivers, while those of the second type as plural-screen television receivers.

In the single-screen television receiver, audiovisual outputs supplied only by a selected single audiovisual signal source are presented (that is, displayed as images and produced as audio). In the plural-screen television receiver, on the other hand, video outputs supplied by different audiovisual signal sources are simultaneously displayed as many as the number of sub-screens on the monitor, while audio output is produced from only a specific audiovisual signal source selected.

In the above-mentioned single- and plural-screen television receivers, how an emergency message, typified by a visual emergency alert displayed on a screen, for informing viewers of a disaster, breaking news, or the like, is received and produced is briefly described below. Normally, such an emergency message is broadcasted as being carried on broadcast radio waves transmitted from a general broadcasting station or on radio waves equal in frequency band to the broadcast radio waves.

In the single-screen television receiver, if a broadcasting station to broadcast an emergency message has been selected as the audiovisual signal source for display, the incoming emergency message is automatically presented from the single-screen television receiver as video or audio output during normal broadcasting. If, however, an external device such as a VCR or a television game machine is selected as the audiovisual signal source for display, the incoming emergency message cannot be presented by single-screen television receiver although receivable.

As such, while audiovisual signals from an external device are being reproduced, the single-screen television receiver cannot recognize any incoming emergency message even though it is capable of receiving and presenting the emergency message while powered on. This poses a serious problem especially when the emergency message delivers emergency information critical to people's lives such as an earthquake or tsunami warning, or breaking news.

In the plural-screen television receiver, on the other hand, when one or more sub-screens display video supplied by the corresponding broadcasting stations, the incoming emergency message can be presented on the displaying sub-screens. However, in a case where the emergency message is composed of not characters or images but only of audio, the viewer will not even be aware of reception of the emergency message if audio output corresponding to the video being played on the sub-screen has not been selected as the audio output to be produced from the plural-screen television receiver. Moreover, even when the emergency message is composed of characters or images, the emergency message may be too small to be conspicuously displayed on the sub-screen, making it difficult for viewers to notice the message. As such, unlike the single-screen television receiver, the plural-screen television receiver can technically present the emergency message but, in practice, like the single-screen display television receiver, the plural-screen television receiver can hardly achieve a primary object of promptly delivering important information in case of an emergency.

### SUMMARY OF THE INVENTION

Therefore, the present invention is devised in consideration of the problems associated with reception and presentation of emergency messages in conventional television receivers. An object of the present invention is to provide an automatic emergency message display television receiver capable of receiving and presenting an emergency message to viewers irrespectively of which type of an audiovisual signal source has been selected.

The present invention has the following features to attain the object mentioned above.

According to a first aspect of the present invention, an automatic emergency message display television receiver automatically displays an emergency message carried on a broadcast wave as being superposed on a screen that is displaying video reproduced from audiovisual signals supplied by a plurality of audiovisual signal sources. The automatic emergency message display television receiver includes:

emergency message reproducing means for receiving the broadcast wave and reproducing the emergency message; and

emergency message display means for displaying the reproduced emergency message on the screen.

As described above, in the first aspect, in a case where video is being displayed on a display unit in response to a signal from an external device such as a VCR or a television game machine when an emergency message containing breaking news or the like is broadcasted from a broadcasting station, the emergency message can be combined with the video from the external device for display.

According to a second aspect based on the first aspect, the automatic emergency message display television receiver further includes emergency message display time control means for displaying the reproduced emergency message for a predetermined time period.

As described above, in the second aspect, the received emergency message can be displayed on the screen for a desired time period.

According to a third aspect based on the first aspect, when the broadcast wave is an analog broadcast wave, the emergency message reproducing means includes:

audiovisual signal reproducing means for reproducing a first video signal and a first audio signal from the broadcast wave;

audio signal storage means for storing a second audio signal uniquely included in the emergency message;

emergency message reception detecting means for comparing the first audio signal with the second audio signal and, when the first audio signal coincides with the second audio signal, determining that the first video signal includes the emergency message; and

emergency message extracting means for extracting the emergency message from the first video signal when the emergency message reception detecting means determines that the first video signal includes the emergency message.

According to a fourth aspect based on the third aspect, the audiovisual signal reproducing means includes:

an analog tuner for generating an intermediate frequency signal from the broadcast wave;

audio/video signal separating means for separating the intermediate frequency signal into a video intermediate frequency signal and an audio intermediate frequency signal;

video A/D converting means for performing A/D conversion of the video intermediate frequency signal, and generating the first video signal; and

audio A/D converting means for performing A/D conversion of the audio intermediate frequency signal, and generating the first audio signal.

According to a fifth aspect based on the first aspect, when the broadcast wave is a digital broadcast wave, the emergency message reproducing means includes:

reproducing means for reproducing additional information and a first audio signal from the broadcast wave;

audio signal storage means for storing a second audio signal uniquely included in the emergency message;

emergency message reception detecting means for comparing the first audio signal with the second audio signal and, when the first audio signal coincides with the second audio signal, determining that the additional information includes the emergency message; and

emergency message extracting means for extracting the emergency message from the additional information when the emergency message reception detecting means determines that the additional information includes the emergency message.

According to a sixth aspect based on the fifth aspect, the reproducing means includes:

a digital tuner for extracting a transport stream from the broadcast wave; and

additional information/audio signal separating means for separating the transport stream into the additional information and the first audio signal.

According to the seventh aspect based on the first aspect, when the broadcast wave is a digital broadcast wave, the emergency message reproducing means includes:

additional information reproducing means for reproducing additional information from the broadcast wave;

emergency message detecting means for detecting information indicative of the presence of the emergency message included in the additional information; and

emergency message extracting means for extracting the emergency message from the additional information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the construction of an automatic emergency broadcast display television receiver according to a first embodiment of the present invention;

FIG. 2 is a flowchart showing the operation of the automatic emergency broadcast display television receiver illustrated in FIG. 1;

FIG. 3 is a block diagram illustrating the construction of an automatic emergency broadcast display television receiver according to a second embodiment of the present invention; and

FIG. 4 is a flowchart showing the operation of the automatic emergency broadcast display television receiver illustrated in FIG. 3.

### DESCRIPTION OF THE PREFERRED EMBODIMENTS

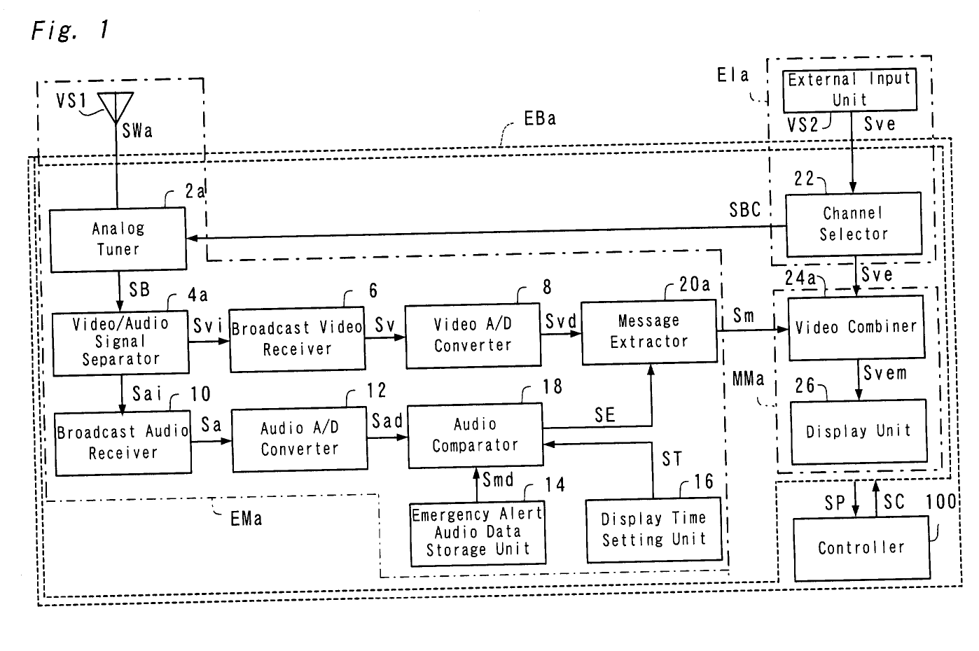

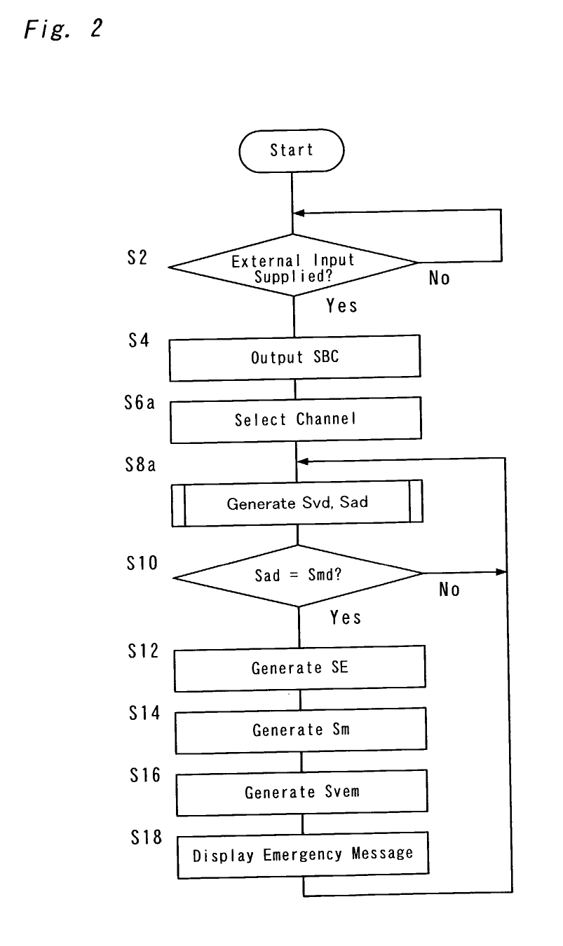

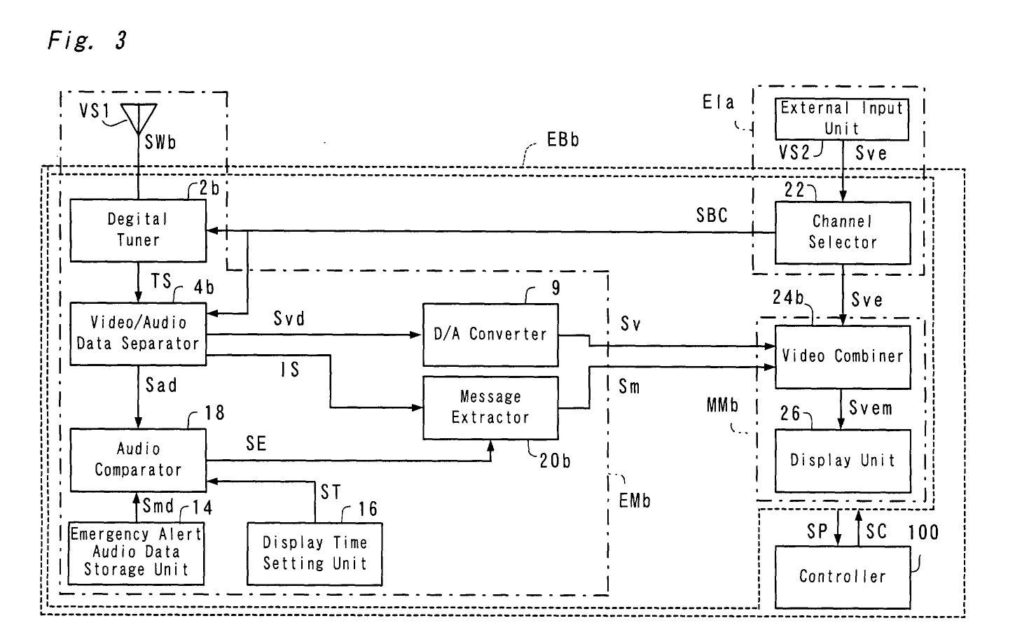

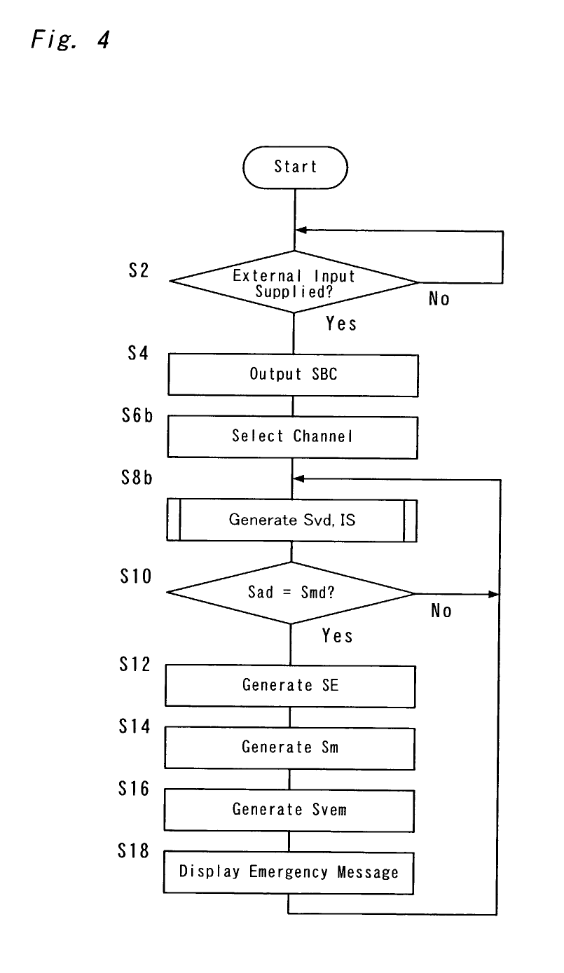

With reference to FIGS. 1 and 2, an automatic emergency message display television receiver according to a first embodiment of the present invention is described below, which is applied to a case where an emergency message is transmitted on an analog broadcast wave. Then, with reference to FIGS. 3 and 4, an automatic emergency message display television receiver according to a second embodiment of the present invention is described, which is applied to a case where an emergency message is transmitted on an digital broadcast wave.

(First embodiment)

As illustrated in FIG. 1, an automatic emergency message display television receiver EBa (hereinafter simply referred to as “television receiver EBa”) includes an analog tuner 2a, a video/audio signal separator 4a, a broadcast video receiver 6, a video A/D converter 8, a broadcast audio receiver 10, an audio A/D converter 12, an emergency alert audio data storage unit 14, a display time setting unit 16, an audio comparator 18, a message extractor 20a, a channel selector 22, a video combiner 24a, a presenting unit 26, and a controller 100. The controller 100 controls the entire operation of the television receiver EBa by generating control signals SC based on state signals SP supplied by the respective components that construct the television receiver EBa.

Broadly speaking, the television receiver EBa is connected to two types of video signal sources: a broadcasting station and an external device. That is, the television receiver EBa receives an analog broadcast wave Swa from the broadcasting station via an antenna VS1, and is also supplied with an audiovisual signal Sve from the external device, such as a VCR or a home television game machine, via an external input unit VS2. The analog broadcast wave Swa carries an emergency message as required. Alternatively, the emergency message may be carried on a broadcast wave transmitted not via the antenna VS1 but through wires, such as a cable television broadcast wave.

Here, the television receiver EBa includes three systems: an emergency message reception system EMa, an external device audiovisual signal input system EIa, and an emergency message multiplex and presentation system MMa. The emergency message reception system EMa is formed by the antenna VS1, the analog tuner 2a, the video/audio signal separator 4a, the broadcast video receiver 6, the video A/D converter 8, the broadcast audio receiver 10, the audio A/D converter 12, the emergency alert audio data storage unit 14, the display time setting unit 16, the audio comparator 18, and the message extractor 20a. The external device audiovisual signal input system EIa is formed by the external input unit VS2 and the channel selector 22. The emergency message multiplex and presentation system MMa is formed by the video combiner 24a and the presenting unit 26 for multiplexing an emergency message with an image, for example, outputted from the external input system EIa. These three systems are described below in sequence.

First, in the emergency message reception system EMa, the analog tuner 2a extracts, from the analog broadcast wave SWa, a broadcast wave transmitted from a desired broadcasting station, and then outputs an intermediate frequency (IF) signal SB. The video/audio signal separator 4a separates the IF signal SB into a video IF signal Svi and an audio IF signal Sai for output.

The broadcast video receiver 6 generates a broadcast video signal Sv from the video IF signal Svi. The video A/D converter 8 performs A/D conversion of the broadcast video signal Sv to generate broadcast video data Svd.

The broadcast audio receiver 10 generates a broadcast audio signal Sa from the audio IF signal Sai. The audio A/D converter 12 performs A/D conversion of the broadcast audio signal Sa to generate broadcast audio data Sad. The emergency alert audio data storage unit 14 previously stores an audible alert, such as a chime, for drawing viewer's attention before the emergency message is presented, as alert audio data Smd. The emergency alert audio data storage unit 14 supplies the alert audio data Smd to the audio comparator 18. The display time setting unit 16 stores information representing a predetermined time period T as time data ST, and supplies the time data ST to the audio comparator 18.

The audio comparator 18 compares the audio data Sad supplied by the audio A/D converter 12 and the alert audio data Smd. When the audio data Sad coincides with the alert audio data Smd, the audio comparator 18 determines that an emergency message has been received, and generates a detection signal SE indicating reception of the emergency message. Furthermore, the audio comparator 18 continuously outputs the detection signal SE for the predetermined time period T represented by the time data ST.

The message extractor 20a responds to the detection signal SE to extract an image, for example, of the emergency message such as an emergency alert included in the broadcast video data Svd supplied by the video A/D converter 8 as a message signal Sm, and outputs the message signal Sm to the video combiner 24a. The message signal Sm is continuously supplied during the time period T defined by the time data ST. Therefore, the message extractor 20a can continuously extract the emergency message included in the broadcast video signal Sv over the predetermined time period T.

Alternatively, to deal with a case where the emergency message ends before the predetermined time period T lapses, the message extractor 20a may be provided with a frame buffer of a predetermined capacity for output of the already-extracted emergency message as the message signal Sm. For example, to generate the message signal Sm, the message extractor 20a stores the broadcast video data Svd outputted from the video A/D converter 8 in the frame buffer, and extracts data representing a portion displayed on an upper portion of the screen and having white-color information from the stored video data.

In the external device audiovisual signal input system EIa, the channel selector 22 responds to an audiovisual signal Sve supplied via the external input unit VS2 to output, to the analog tuner 2a, a channel selecting signal SBC for designating a broadcasting station from which an emergency message is to be received. Thus, it is possible to continuously receive the broadcast wave SWa possibly carrying an emergency message to be presented on the background while video is played by the television receiver EBa based on the audiovisual signals from the external device. Therefore, the incoming emergency message can be promptly superposed on the video from the external device for display, enabling the viewer to notice the emergency message without delay.

In the emergency message multiplex and presentation system MMa, the video combiner 24a combines the message signal Sm with the audiovisual signal Sve supplied by the channel selector 22 to generate an audiovisual signal Svem. Based on this audiovisual signal Svem, the display unit 26 produces an emergency message of a predetermined size on a screen. Therefore, a single, large-sized emergency message can be displayed across the entire screen, thereby effectively drawing a viewer's attention.

With reference to a flowchart of FIG. 2, the operation of automatically displaying an emergency message to be performed by the television receiver EBa is described below. This operation is started when the television receiver EBa is powered on.

First, in step S2, it is determined whether any audiovisual signal input has been externally supplied via the external input unit VS2. If it is determined that such an input has been externally supplied, the control procedure goes to the next step S4.

In step S4, the channel selector 22 outputs a channel selecting signal SBC to the analog tuner 2a. The control procedure then goes to the next step S6a.

In step S6a, the analog tuner 2a responses to the channel selecting signal SBC to extract, from the analog broadcast wave SWa, the intermediate frequency signal SB transmitted from a specific broadcast station. The control procedure then goes to the next step S8a.

In step S8a, the broadcast video data Svd is generated through the video/ audio signal separator 4a, the broadcast video receiver 6, and then the video A/D converter 8, while the audio data Sad is generated through the video/audio signal separator 4a, the broadcast audio receiver 10, and the audio A/D converter 12. The control procedure then goes to the next step S10.

In step S10, the audio comparator 18 determines whether the audio data Sad coincides with the alert audio data Smd. If it is determined that the audio data Sad does not coincide with the alert audio data Smd, the control procedure returns to the above step S8a. If it is determined that the audio data Sad coincides with the alert audio data Smd, the control procedure goes to the next step S12.

In step S12, based on the time data ST, the audio comparator 18 generates a detection signal SE indicating reception of an emergency message. The detection signal SE is continuously supplied to the message extractor 20a for the predetermined time period T. The control procedure then goes to the next step S14.

In step S14, in response to the detection signal SE, the message extractor 20a extracts the emergency message from the broadcast video data Svd to generate a message signal Sm. The message signal Sm is supplied to the video combiner 24a. The control procedure then goes to the next step S16.

In step S16, the video combiner 24a combines the message signal Sm with the audiovisual signal Sve to generate an audiovisual signal Svem. The control procedure then goes to the next step S18.

In step S18, the display unit 26 presents video having the emergency message superposed on the externally-supplied video. The control procedure then returns to the above step S8a to wait for another emergency message to come.

As described above, the television receiver EBa can superpose an emergency message, such as a message containing breaking news transmitted from a broadcasting station, with video being reproduced from audiovisual signals transmitted from an external device such as a VCR or a television game machine. Thus, the possibility of missing important life-threatening information can be reduced.

Furthermore, even in a case where the viewer is watching video transmitted from the external device when the broadcasting station designated by the viewer transmits an emergency message, the viewer can view the emergency message as being superposed on the video from the external device.

Therefore, the possibility of missing important information can be reduced. This can also apply to a case where the viewer is watching video transmitted from the designated external device when the viewer-designated broadcasting station transmits an emergency message with a chime preceding thereto.

Still further, in the above latter case, the user can view the emergency message superposed on the video from the external device for a time period designated by the viewer. This can also contribute reduction in possibility of missing important information.

(Second embodiment)

As illustrated in FIG. 3, an automatic emergency message display television receiver EBb (hereinafter simply referred to as “television receiver EBb”) according to a second embodiment of the present invention is similar in structure to the television receiver EBa illustrated in FIG. 1, except that, in the television receiver EBb, the analog tuner 2a is replaced with a digital tuner 2b; the video/audio signal separator 4a with a video/audio data separator 4b; the message extractor 20a with a message extractor 20b; and a video combiner 24a with a video combiner 24b.

Also, in FIG. 3, a D/A converter 9 is newly provided, while the broadcast video receiver 6, the video A/D converter 8, the broadcast audio receiver 10, and the audio A/D converter 12 are not provided. Consequently, the emergency message reception system EMa is replaced with an emergency message reception system EMb; and the emergency message multiplex and presentation system MMa with an emergency message multiplex and presentation system MMb.

That is, the television receiver EBb receives a digital broadcast wave SWb transmitted from a broadcasting station via the antenna VS1, and also is supplied with an audiovisual signal Sve from an external device, such as a VCR or a home television game machine, via the external input unit VS2. An external device audiovisual signal input system EIa is similar to that in the first embodiment, and therefore is not described herein. Hereinafter, an emergency message reception system EMb formed by the digital tuner 2b, the video/audio data separator 4b, the D/A converter 9, the emergency alert audio data storage unit 14, the display time setting unit 16, the audio comparator 18, and the message extractor 20b is mainly described below, and then the emergency message multiplex and presentation system MMb is briefly described further below.

First, in the emergency message reception system EMb, the digital tuner 2b extracts, from the digital broadcast wave SWb, a transport stream TS transmitted from a desired broadcasting station. The video/audio data separator 4b separates the transport stream TS into broadcast video data Svd, audio data Sad, and additional information IS. Note that, when a channel selecting signal SBC is supplied by the channel selector 22, the video/audio data separator 4b outputs only the audio data Sad and the additional information IS.

As with the analog tuner 2a, the digital tuner 2b responds to the channel selecting signal SBC to perform channel selection. This enables the television receiver EBb to receive a broadcast wave SWb possibly carrying an emergency message for display in the background while displaying video based on audiovisual signals from the external device.

The D/A converter 9 performs D/A conversion of broadcast video data Svd supplied by the video/audio data separator 4b to generate a broadcast video signal Sv for output to the video combiner 24b.

The audio comparator 18 compares the audio data Sad from the video/audio data separator 4b with the alert audio data Smd. When the audio data Sad coincides with the alert audio data Smd, it is determined that the emergency message has been received. Based on the determination, the audio comparator 18 generates a detection signal SE indicating reception of the emergency message. Furthermore, the audio comparator 18 continuously outputs the detection signal SE to the message extractor 20b over the predetermined time period T represented by the time data ST.

In response to the detection signal SE, the message extractor 20b extracts, from the additional information IS supplied by the video/audio data separator 4b, an image, for example, of the emergency message, such as a visual emergency alert, as the message signal Sm for output to the video combiner 24b. This message signal Sm is continuously supplied over the predetermined time period T defined by the time data ST, and therefore the message extractor 20b can extract the emergency message included in the additional information IS over the predetermined time period T. To deal with a case where the emergency message ends before the predetermined time period T lapses, the message extractor 20b may be provided, as with the message extractor 20a, with a frame buffer of a predetermined capacity for output of the already-extracted emergency message as the message signal Sm.

In the emergency message multiplex and presentation system MMb, the video combiner 24b combines the message signal Sm supplied by the emergency message reception system EMb with the audiovisual signal Sve supplied by the external device audiovisual signal input system EIa to generate an audiovisual signal Svem. Note that, as described above, when the external device audiovisual signal input system EIa is supplied with an audiovisual signal from an external device, the broadcast video data Svd is not output from the video/audio data separator 4b. When not the external device but the broadcasting station that broadcasts the broadcast wave SWb is selected as the audiovisual signal source, the broadcast video data Svd is output from the video/audio data separator 4b to the D/A converter 9, where a broadcast video signal Sv is generated. In the video combiner 24b, the broadcast video signal Sv and the message signal Sm are combined together, thereby generating the audiovisual signal Svem.

With reference to a flowchart shown in FIG. 4, the operation of automatically displaying an emergency message to be performed by the television receiver EBb is described below. The operation in the second embodiment is similar to that to be performed by the television receiver EBa except that steps S6a and S8a in the flowchart of FIG. 2 are replaced with steps S6b and S8b.

In short, in step S6b, the digital tuner 2b responds to the channel selecting signal SBC to extract from the digital broadcast wave SWb the transport stream TS transmitted from a predetermined broadcasting station. Then, in step S8b, the audio data Sad and the additional information IS are generated.

As described above, in the second embodiment, as with the first embodiment, the audio data Sad is compared with the alert audio data Smd to detect reception of an emergency message. However, if the additional information IS includes, as a code C (not shown), information indicative of the presence or start of an emergency message contained in the transport stream this code C may be extracted by the message extractor 20b to detect the reception of the emergency message. In this case, the message extractor 20b includes a code extractor (not shown).

While the invention has been described in detail, the foregoing description is in all aspects illustrative and not restrictive. It is understood that numerous other modifications and variations can be devised without departing from the scope of the invention.

What is claimed is:

1. An automatic emergency message display television receiver for automatically displaying an emergency message carried on a broadcast wave as being superposed on a screen that is displaying video reproduced from audiovisual signals supplied by a plurality of audiovisual signal sources, the automatic emergency message display television receiver comprising:
emergency message reproducing means for receiving the broadcast wave and reproducing the emergency message; and
emergency message display means for displaying the reproduced emergency message on the screen.

2. The automatic emergency message display television receiver according to claim 1, further comprising:
emergency message display time control means for displaying the reproduced emergency message for a predetermined time period.

3. The automatic emergency message display television receiver according to claim 1, wherein
when the broadcast wave is an analog broadcast wave, the emergency message reproducing means includes:
audiovisual signal reproducing means for reproducing a first video signal and a first audio signal from the broadcast wave;
audio signal storage means for storing a second audio signal uniquely included in the emergency message;
emergency message reception detecting means for comparing the first audio signal with the second audio signal and, when the first audio signal coincides with the second audio signal, determining that the first video signal includes the emergency message; and
emergency message extracting means for extracting the emergency message from the first video signal when the emergency message reception detecting means determines that the first video signal includes the emergency message.

4. The automatic emergency message display television receiver according to claim 3, wherein
the audiovisual signal reproducing means includes:
an analog tuner for generating an intermediate frequency signal from the broadcast wave;
audio/video signal separating means for separating the intermediate frequency signal into a video intermediate frequency signal and an audio intermediate frequency signal;
video A/D converting means for performing A/D conversion of the video intermediate frequency signal, and generating the first video signal; and
audio A/D converting means for performing A/D conversion of the audio intermediate frequency signal, and generating the first audio signal.

5. The automatic emergency message display television receiver according to claim 1, wherein
when the broadcast wave is a digital broadcast wave, the emergency message reproducing means includes:
reproducing means for reproducing additional information and a first audio signal from the broadcast wave;
audio signal storage means for storing a second audio signal uniquely included in the emergency message;
emergency message reception detecting means for comparing the first audio signal with the second audio signal and, when the first audio signal coincides with the second audio signal, determining that the additional information includes the emergency message; and
emergency message extracting means for extracting the emergency message from the additional information when the emergency message reception detecting means determines that the additional information includes the emergency message.

6. The automatic emergency message display television receiver according to claim 5, wherein
the reproducing means includes:
a digital tuner for extracting a transport stream from the broadcast wave; and
additional information/audio signal separating means for separating the transport stream into the additional information and the first audio signal.

7. The automatic emergency message display television receiver according to claim 1, wherein
when the broadcast wave is a digital broadcast wave, the emergency message reproducing means includes:
additional information reproducing means for reproducing additional information from the broadcast wave;
emergency message detecting means for detecting information indicative of the presence of the emergency message included in the additional information; and
emergency message extracting means for extracting the emergency message from the additional information.
